(19) United States
(12) Patent Application Publication
(10) Pub. No.: US 2005/0229168 A1
(43) Pub. Date: Oct. 13, 2005

(54) Cross-platform user interface development method

(76) Inventors: Sayling Wen, Taipei (TW); Zechary Chang, Taipei (TW); Hogan Zhang, Beijing (CN)

Correspondence Address: BIRCH STEWART KOLASCH & BIRCH, PO BOX 747, FALLS CHURCH, VA, 22040-0747, US

(21) Appl. No.: 10/819,135

(22) Filed: Apr. 7, 2004

(51) Int. Cl. G06F 9/45; G06F 9/44

(52) U.S. Cl. 717/147; 717/101; 717/114

(57) ABSTRACT

A cross-platform user interface development method can easy management and maintenance for the interfaces to have a development process that does not depend on any specific language or operating system. The method first provides all interface elements to the user, and then gathers interface element property data configured by user, saves these data as a XML format file, searches the form nodes in said file, traversals all the elements in all element sets in the node, and finally generates each element according to the element propertys.

### BACKGROUND OF THE INVENTION

1. Field of Invention

The present invention relates to a development method for the graphics user interface in a computer program, especially a development method for cross-platform user interface.

2. Related Art

In any computer software, lots of graphics user interfaces (GUI) are needed. Nowadays, different development tools, such as VB, Delphi, etc, are used to produce these interfaces. However, since these development tools depend on certain kinds of operating platforms, not only the development environment is limited, the operation environment is also limited. If these interface programs operate on a non-compatible operating platform, the user interface cannot be defined normally so it creates a significant portability problem of the program.

Also, the current application programs require not only efficient code but also user friendly interactions. Since mass usage of the user interfaces can efficiently solve the user friendly problem, current programs have not only a large number of user interfaces but also many different interface types. However, although the number of interfaces is large, there is not a big difference between the codes of different designs since only small changes are made; for example, for the popular skin-change programs, since only some color and shape are varied, the overall interface structure does not change much. The known development method flow does not support efficient management over the large amount of interface programs, therefore, it is not time or energy efficient to change the small differences between the interfaces.

### SUMMARY OF THE INVENTION

The invention solves the described problem and provides a cross-platform user interface development method, to avoid the limitations of known technology placed on development tool and method by the different operating platforms.

The invention provides a cross-platform user interface development method: first provide all interface elements to the user, and then gather the interface element property data configured by the user, and store data in groups into a XML format file, and search for the form nodes in the file, traversal all the elements in all element groups in the node, and generate each element according to the element property.

Since the invention uses the generated and stored XML files to extract all interface related elements from the code and systematically organizes the elements, each interface is managed and maintained. Also, since XML language has the cross-platform characteristics, the development process does not dependent on any specific language or operating system.

Further scope of the applicability of the present invention will become apparent from the detailed description given hereinafter. However, it should be understood that the detailed description and specific examples, while indicating preferred embodiments of the invention, are given by way of illustrations only, and various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow as illustration only; thus are not limitative of the present invention, and wherein:

FIG. 1 illustrates the flow chart of the invention of cross-platform user interface development method.

FIG. 2 illustrates the described editing area of the invention.

FIG. 3 illustrates the described element insertion into the editing area of the invention.

FIG. 4-1 to 4-6 illustrates the example of XML format data storage of the invention.

### DETAILED DESCRIPTION OF THE INVENTION

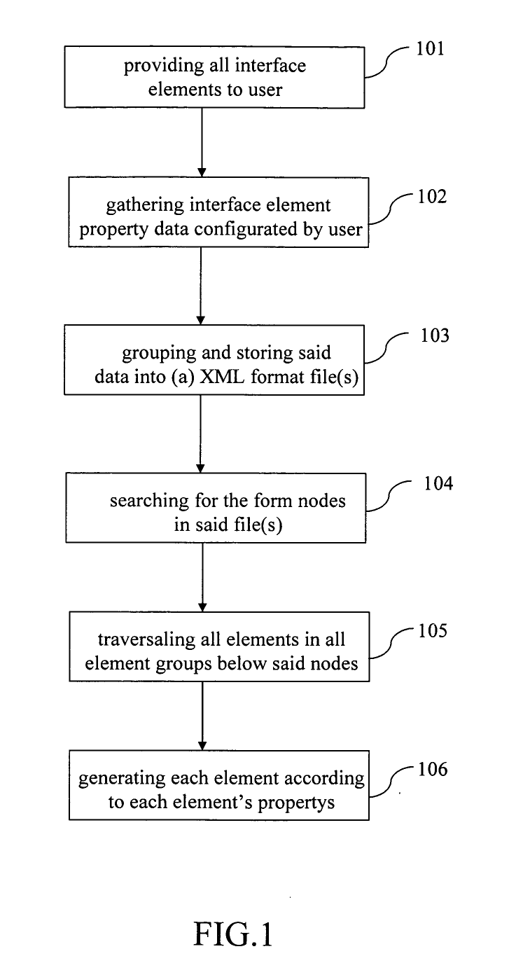

This invention provides a cross-platform user interface development method. Please refer to FIG. 1 for the flow chart of the invention. This invention first provides all interface elements to the user (step 101); then gathers interface element property data configured by user (step 102), stores these data in groups into a XML format file (step 103), searches the form nodes in these file (step 104), traversals all the elements in all element groups below the node (step 105), and generates each element according to the element propertys (step 106).

The described form can be a dialog box; the nodes have node tags, such as “Dialog”. The step of searching for the form nodes is done by using the node tags and matching Name propertys for verification.

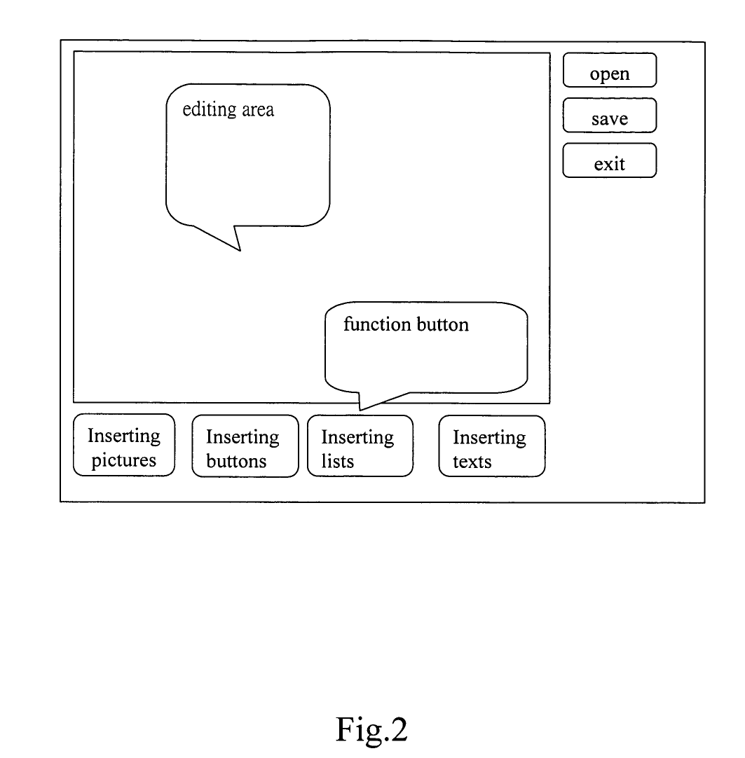

Please refer to FIG. 2; this invention uses an editing area to animatedly and visibly provide all interface elements to users. Using the presentation of the editing area, user is allowed to put in different kinds of interface elements. The elements usually consist of forms, pictures, buttons, lists, text, etc. The propertys of each of the elements usually include name, size, color, position, etc. Using the function button in the editing area can allow the insertion of different kinds of elements into the editing area.

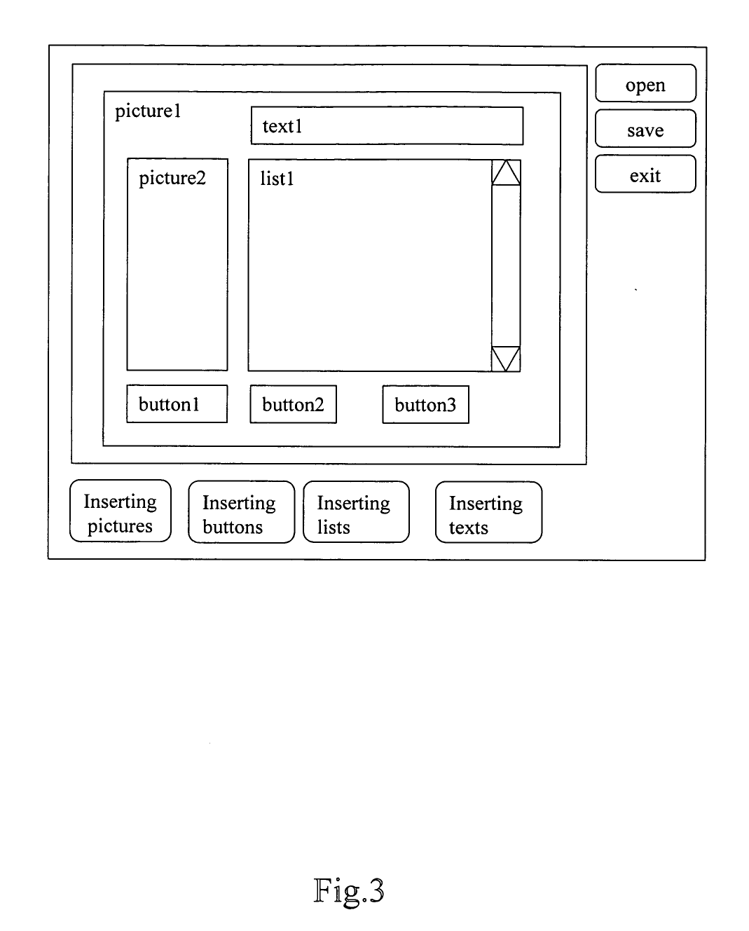

Please refer to FIG. 3; each of the interface elements in the editing area can be moved freely and their size can be adjusted to form specific propertys. Once satisfaction is reached, the save button is used to save the data file in the XML format.

In the XML format file, the same type of elements and their properties are stored as a group in sequence.

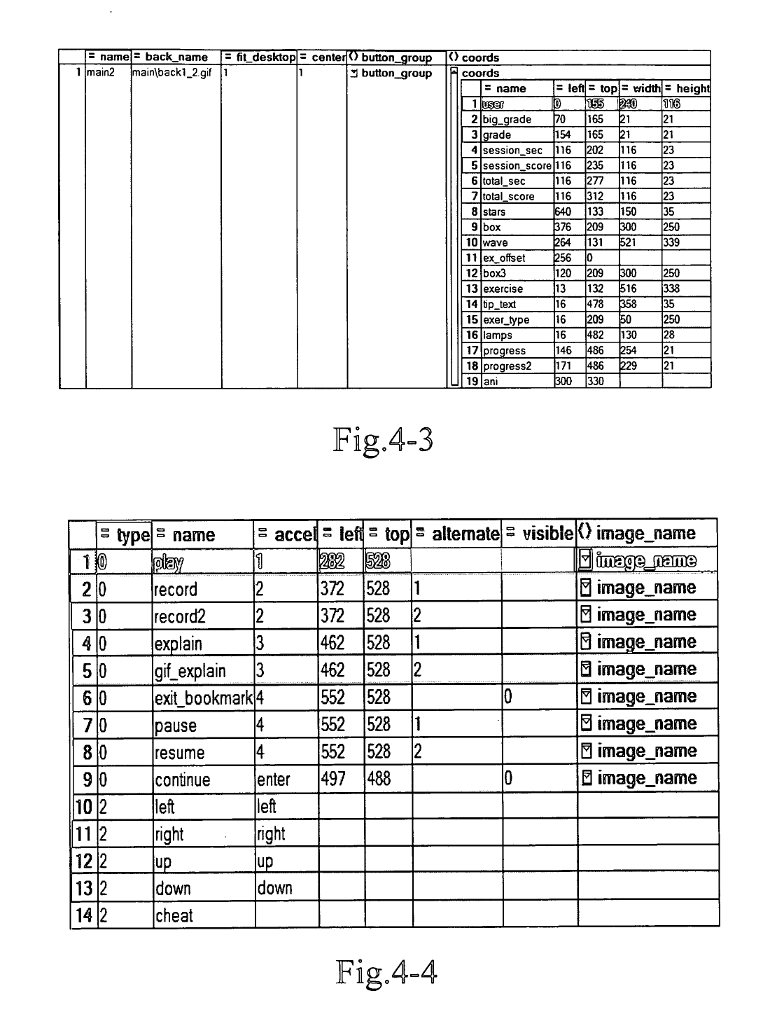

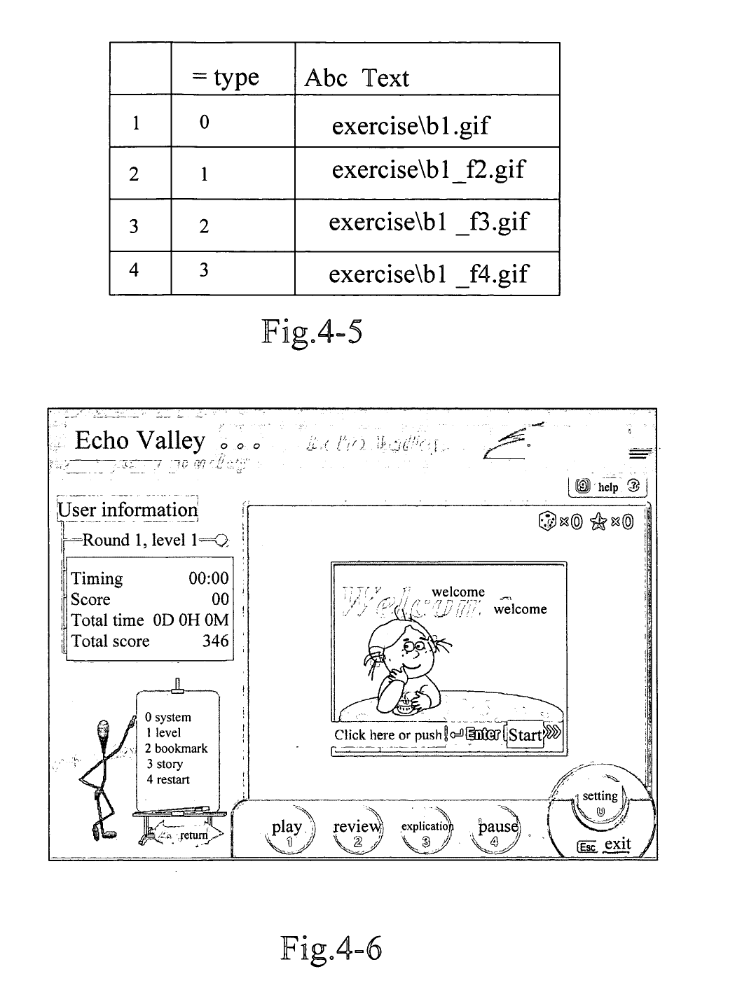

Please refer to FIG. 4-1 to 4-6 for the XML stored data file format example. In the file,
<dialog name=“main2” back_name=“main\back1_{—}2.gif”>:
   node “dialog” denotes a dialog box;
   property “name” denotes the name of the dialog box;
   property “back_name” denotes the name of the background picture of the dialog box.
<button_group name=“controls” enabled=“0” auto_create=“0”>:
   node “button_group” is a button group of the dialog box;
   property “name” is the name of the button group;
   property “enabled” denotes if the button group is enabled in the program;
   property “auto_create” denotes if the button group is automatically created.
<button type=“0” name=“grade” accel=“1” left=“115” top=“411” value=“0”>
   node “button” is a button in the button group;
   property “type” is the button type;
   0 represents the button has a shape (the node includes the sub-node of image_name);
   1 represents the button has no shape (the node does not include the sub-node of image_name);
   property “name” is the name of the button;
   property “accel” is the hot key for the button;
   property “left top” is the top left coordinates for the button;
   property “value” is the numerical value represented by the button;
<image_name type=“0”>controls\a2-1.gif</image_name>
<image_name type=“1”>controls\a2-2.gif</image_name>
<image_name type=“2”>controls\a2-3.gif</image_name>
<image_name type=“3”>controls\a2-4.gif</image_name>
<image_name type=“4”>controls\a2-1.gif</image_name>
   node “image_name” is the background image of the button;
   property “type” is the type of the background image;
   0 represents normal;
   1 represents bright;
   2 represents pressed;
   3 represents invalid;
   4 represents selected;
   5 represents selected and invalid;
   6 represents selected and brightened;
</button>
<button type=“0” name=“options” accel=“0” left=“115” top=“376” value=“1”>
<image_name type=“0”>controls\a1-1.gif</image_name>
<image_name type=“1”>controls\a1-2.gif</image_name>
<image_name type=“2”>controls\a1-3.gif</image_name>
<image_name type=“3”>controls\a1-4.gif</image_name>
<image_name type=“4”>controls\a1-1.gif</image_name>
</button>

Due to space constraint, some button explanations are omitted.
</button_group>

Due to space constraint, some button explanations are omitted.
<coords name=“user” left=“0” top=“155” width=“240” height=“116”/>
<coords name=“big_grade” left=“70” top=“165” width=“21” height=“21”/>
<coords name=“grade” left=“154” top=“165” width=“21” height=“21”/>
<coords name=“ex_offset” left=“256” top=“0”/>
<coords name=“box3” left=“120” top=“209” width=“300” height=“250”/>
</dialog>

A complete application program can have more than one dialog box, the explanation of the other dialogs are omitted.

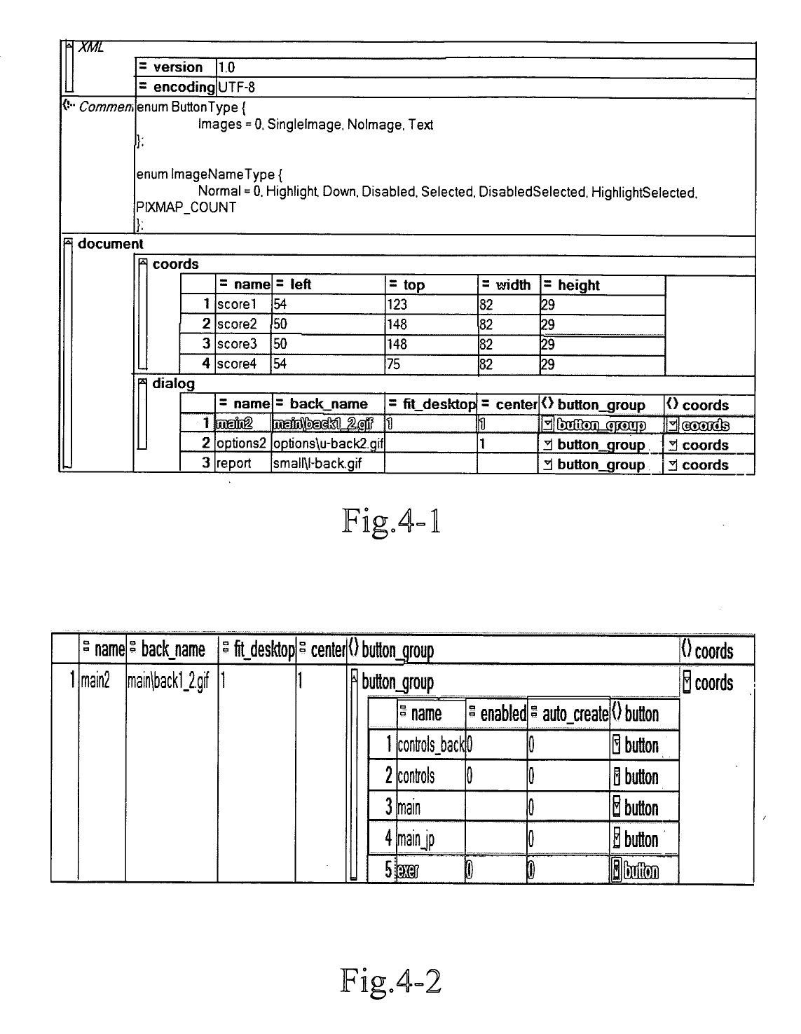

FIG. 4-6 is the user interface generated using the described XML data file. Since all interface related elements can be extracted from the code in the data file's data structure, and constructed systematically, the management and maintenance of the each interface are a lot more convenient, and the implementation of the multi-language versions of the program as well as animated skin-change programs can be easily done. Also, since the XML language has a cross-platform characteristic, the development process does not depend on any specific language or operating system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A cross-platform user interface development method comprises of:
providing all interface elements to user;
gathering interface element property data configured by user;
grouping and storing said data into (a) XML format file(s);
searching for the form nodes in said file(s);
traversaling all elements in all element groups below said nodes; and
generating each element according to each element's propertys.

2. The cross-platform user interface development method as described in claim 1, wherein said step of providing user all interface elements uses an editing area to allow user to place each interface element.

3. The cross-platform user interface development method as described in claim 2, wherein said editing area's interface element can be moved freely and its size can be adjusted to form the specific propertys.

4. The cross-platform user interface development method as described in claim 1, wherein said step of storing said data in groups in XML format file is to store same type of elements and its propertys data in a group and store them in sequence.

5. The cross-platform user interface development method as described in claim 1, wherein said form is a dialog box.

6. The cross-platform user interface development method as described in claim 1, wherein said node has a node tag.

7. The cross-platform user interface development method as described in claim 1, wherein said step of searching for said form nodes in said file uses the node tags and its matching Name property for verification.
